(19) United States
(12) Patent Application Publication
(10) Pub. No.: US 2026/0133857 A1
(43) Pub. Date: May 14, 2026

(54) DYNAMIC WORKER RECONFIGURATION ACROSS WORK QUEUES

(71) Applicant: HITACHI VANTARA LLC, Santa Clara (CA)

(72) Inventors: Richard D BRAMANTE, Jr., North Billerica, MA (US); Timothy M PALACE, Glen, NH (US); Mariusz KULMA, Auburn, MA (US)

(21) Appl. No.: 19/118,128

(22) PCT Filed: Oct. 28, 2022
(86) PCT No.: PCT/US2022/048134

§ 371 Date: Apr. 3, 2025

(51) Int. Cl. G06F 9/54

(52) U.S. Cl. CPC G06F 9/546; G06F 2209/548

(57) ABSTRACT

In some examples, a computing device may generate a plurality of queues configured to receive data. The computing device may also generate a plurality of worker instances, each of which may be associated with a respective queue for consuming data from the respective queue. Individual worker instances receive system configuration information indicating a state of the respective queues and a state of the respective worker instances. Further, each of the individual worker instances is configured to determine, based at least on the received system configuration information, whether to change an association of the individual worker instance from the queue with which the individual worker instance is currently associated to a different queue. Based at least on the received system configuration information, at least one of the individual worker instances determines to change association from a first one of the queues to a second one of the queues.

### TECHNICAL FIELD

This disclosure relates to the technical field of data processing.

### BACKGROUND

In a distributed work queue system, worker nodes may be scaled (e.g., increased in number or processing capacity) to provide an increase in processing bandwidth to the system. However, if the number of worker nodes is scaled to an extent that is beyond what the queuing system is able to support, the processing bandwidth may suffer. A conventional solution to this issue might be to also increase in scale the number of work queues to further partition the queuing system. Accordingly, the number of work queues in the system and the number of worker nodes can be scaled independently of each other. However, this situation can lead to performance degradation if the work queues themselves are not balanced (e.g., for even distribution of events) or if the worker nodes are not evenly distributed across the queue set. Further, errors in rebalancing may lead to situations in which orphaned queues exist (e.g., queues having no assigned workers), which may lead to gaps in event processing.

### SUMMARY

Some implementations include a computing device that generates a plurality of queues configured to receive data. The computing device may also generate a plurality of worker instances, each of which may be associated with a respective queue for consuming data from the respective queue. Individual worker instances receive system configuration information indicating a state of the respective queues and a state of the respective worker instances. Further, each of the individual worker instances is configured to determine, based at least on the received system configuration information, whether to change an association of the individual worker instance from the queue with which the individual worker instance is currently associated to a different queue. Based at least on the received system configuration information, at least one of the individual worker instances determines to change association from a first one of the queues to a second one of the queues.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a system able to scale queuing and worker services according to some implementations.

FIG. 2 is a block diagram illustrating an example logical configuration of queuing and consumption operations according to some implementations.

FIG. 3 is a sequence diagram illustrating an example process by which, at start up, a PE worker instance maps itself to a queue or removes itself from a queue according to some implementations.

FIG. 4 is a sequence diagram illustrating an example process by which a PE worker instance, during runtime, maps to a different queue and/or removes itself from a queue according to some implementations.

FIG. 5 illustrates an example data structure used by the self-management algorithm according to some implementations.

FIG. 6 illustrates an example of data structure for state tracking according to some implementations.

FIG. 7 illustrates example pseudocode showing an example of a current system state according to some implementations.

FIG. 8 illustrates an example data structure that the pub/sub program may use to track the PE worker instances according to some implementations.

FIG. 9 illustrates an example data structure indicating current queue type counts according to some implementations.

FIG. 10 illustrates select example components of the service computing device(s) that may be used to implement at least some of the functionality of the systems described herein.

### DESCRIPTION OF THE EMBODIMENTS

Some implementations herein are directed to techniques and arrangements for creating a balance between tasks and workers, thereby resolving scalability issues between components in a distributed work queue system. For example, tasks (e.g., “events”) may be distributed evenly between a plurality of queues. Examples of the events herein may include actions that affect stored data, such as a write request, a put request, a delete request, a move request, and so forth. Additionally, the workers that process the tasks from the queues may manage themselves based on a distributed algorithm for assigning themselves to respective queues (with tasks/events) in a manner that does not require centralized control for assigning the workers to the queues.

Some examples herein may employ a consistent hashing algorithm to distribute incoming events evenly across a queue set. Further the distributed algorithm may be utilized to assign workers to a particular partition of work (e.g., a queue). Based on the distributed algorithm, each worker is able to determine its own queue target without direction from a central manager and without consultation with other workers. Additionally, examples herein may use event mechanisms to detect changes in topology resulting in queue reassignment. Further, configuration constraints may be used to prevent invalid configurations (e.g., orphaned queues). Accordingly, the examples herein resolve scalability issues between components in a distributed work queue system. For instance, some implementations may include a distributed scalable system in which various components are able to be independently scaled, such as based on a particular customer's situation and/or use case.

In implementations herein, queues of different types can exist in the system and workers of different types can also exist in the system. For example, a worker type may be associated with a queue type such that the particular worker will only consume from a queue of the specific type with which that particular worker is associated. Additionally, the queues herein each may have one or more workers corresponding workers as consumers, so that no queues are orphaned. Furthermore, workers may be scaled up to provide more processing of queue events and/or queues may be scaled up to provide support for more workers. Otherwise, a particular queue having too many workers connected might become overburdened. The scaling up of the queues serves to better load-balance the queue workload across the message-queuing computing devices.

The computing system herein may employ a message queuing program, such as a plugin or application, for managing a plurality of work queues. Examples of message queuing programs that may be used in some examples herein may include open-source multi-protocol message brokers such as RABBITMQ® and ACTIVEMQ®. Implementations herein may take into consideration both the scaling of the message queuing program itself (e.g., nodes within a queuing cluster), queues (e.g., how many queues exist and where), and consumers (e.g., services reading from the message queuing program which encompass the “application”, such as a Policy Engine service—also referred to as “PE” herein).

In some examples, the sets of queuing nodes are able to scale independently of each other. To simplify the design and deployment, some examples may include some limit enforcements, e.g., the consumer count should be greater than or equal to the queue count.

Increasing the number of the message queue consumers in the computing system may result in increased event processing (e.g., the message queuing program queues may drain faster with little backlog). Additionally, increasing the number of queuing nodes in the computing system may result in busy consumers (e.g., the consumers do not sit idle waiting for work).

In some implementations, the scaling of the system may include scaling of the message queuing program itself (e.g., queuing nodes within the message queuing cluster), queues (how many queues exist and where), and consumers (services reading from the message queuing program which encompass the “application”, e.g., Policy Engine service—PE). For example, these sets of nodes (queuing nodes and worker nodes) may be scaled independently of each other, but in order to simplify the design and deployment, there may be some limit enforcements, e.g., consumer (worker) count must be greater than or equal to the queue count.

Increasing the number of the message queuing consumers in the system may result in increased event processing (e.g., the message queuing program queues drain faster with little backlog). Increasing the number of the message queuing program nodes in the system may result in busy consumers (e.g., consumers do not sit idle waiting for work, the message queuing program dispatches events as fast as consumers can process them). Accordingly, implementations herein may determine an optimal operating condition for the system, e.g., at an intersection of the message queuing program node count coupled with consumer node count such that the workflow latencies are within accepted limits while the consumer processing is close to 100 percent utilization.

The examples herein may include queue and message durability (e.g., via a replication strategy that allows the system to continue operation with a queuing node loss without interrupting service or losing events) and may also include consumption durability (e.g., events dispatched to queues are never orphaned due to the loss of a consuming instance). Accordingly, implementations herein are able to provide an exchange/queue topology without event loss and with minimal event processing interruption. Further, the system herein is able to manage notifications, synchronization of events, replication, and the like.

Additionally, through a distributed coordination approach, the consumer (Policy Engine worker instances) herein are able to self-determine which queues they should consume from at any given time. In some examples, an administrator may initially set the number of queues of each type for the system, which may be subsequently scaled up or down. The system herein may further include a mechanism for the administrator to adjust some system configuration, and a mechanism to detect and react to changes.

Additionally, the ability for the administrator to declare the number of per-type queues enables the administrator to tailor resources to workflows and system-specific configurations/requirements. As one example, the system may be initially deployed with a default number of queues of each type, which may be adjusted by the administrator after deployment and/or as necessary to accommodate changes in the customer's workflow or load patterns.

In addition, in some examples, queue and worker counts in the system may be defined by an automated process. For example, the process may gather metrics regarding queue and worker performance. Based on analysis of the gathered metrics, the process may determine whether the workers are over-utilized, under-utilized, and further may determine whether the queues are experiencing under subscription or over subscription. Based on the analysis, the process may adjust the system to scale up or down the queue count and/or to scale up or down the worker count. As one example, the process may perform the scaling using one or more application programming interface (API) calls via an API employed by the system.

For discussion purposes, some examples herein are described in the environment of a distributed computer system including a hybrid cloud infrastructure with queue scalability and worker scalability. For example, a computing device of an object storage system may receive objects for storage and may communicate with one or more network storage systems over a network for storing the objects and for providing storage services to users. Further, some examples herein may include a hybrid architecture including a local storage system in communication with one or more remote public cloud and/or private cloud storage systems.

Additionally, while some examples herein are described in the environment of one or more service computing devices in communication with one or more network storage systems for managing storage of data, metadata, event notifications, and the like, implementations herein are not limited to the particular examples provided, and may be extended to any of various other types of computing system architectures and configurations, other types of storage environments, other storage providers, other types of client configurations, other types of data and tasks, and so forth, as will be apparent to those of skill in the art in light of the disclosure herein.

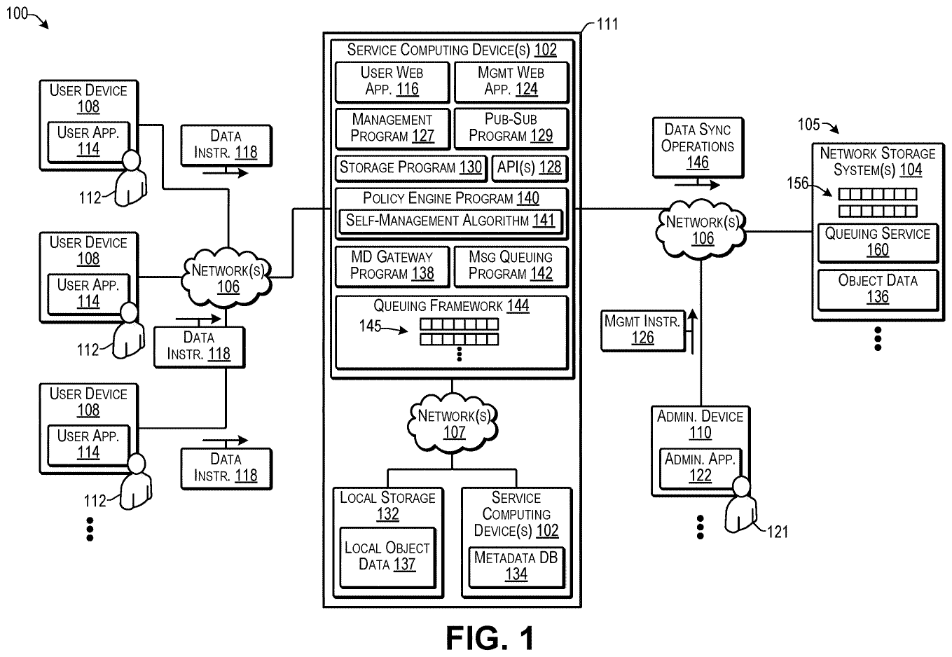

FIG. 1 illustrates an example architecture of a system 100 able to scale queuing and worker services according to some implementations. The system 100 includes a plurality of service computing devices 102 that are able to communicate with, or otherwise coupled to, one or more one network storage systems 104 provided by a service provider 105 through one or more networks 106. In some examples, there may be a plurality of different service providers 105, and each service provider 105 of each different network storage system 104 may be a different entity unrelated to the other service providers 105. Examples of commercial network storage service providers 105 may include AMAZON SIMPLE STORAGE SERVICE (S3), MICROSOFT AZURE, GOOGLE CLOUD, IBM CLOUD, and ORACLE CLOUD, to name a few. The network storage system(s) 104 may be referred to as “cloud storage” or “cloud-based storage” in some examples, and may enable a lower-cost storage solution per gigabyte than local storage that may be available at the service computing devices 102 in some cases. Additionally, in some examples, the storage providers may alternatively be private or otherwise proprietary storage service providers 105 such as for providing access only to specific users, entities, or the like, e.g., associated with the service computing devices 102. An example of a proprietary system service provider 105 may include a configuration of HITACHI CONTENT PLATFORM.

Further, the service computing devices 102 are able to communicate over the network(s) 106 with a plurality of user computing devices 108 and one or more administrator computing devices 110. The user device 108 and the administrator device 110 may be any of various types of computing devices, as discussed additionally below.

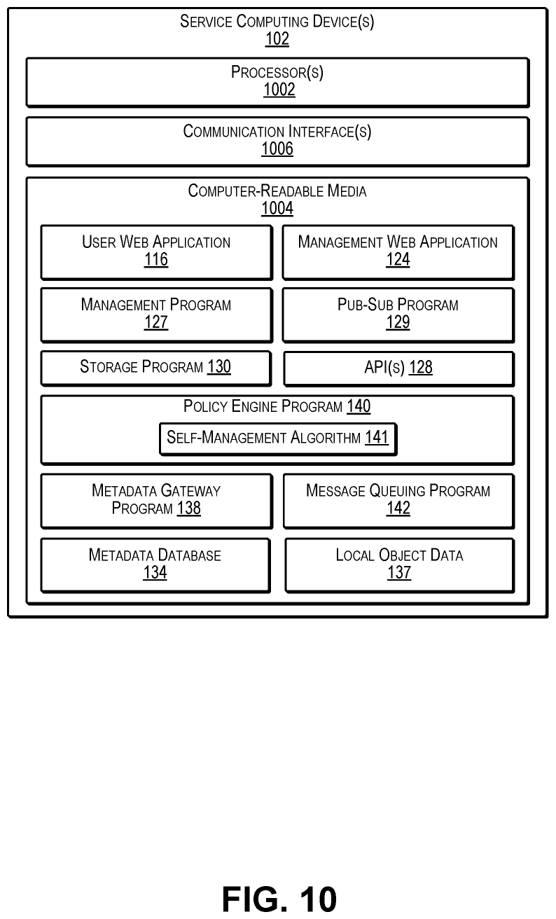

In some examples, the service computing devices 102 may include one or more servers that may be embodied in any number of ways. For instance, the programs, other functional components, and at least a portion of data storage of the service computing devices 102 may be implemented on at least one server, such as in one or more stand-alone servers, a cluster of servers, a server farm, a data center, a cloud-hosted computing service, and so forth, although other computer architectures may additionally or alternatively be used. Additional details of the service computing devices 102 are discussed below with respect to FIG. 10.

In some cases, a plurality of the service computing devices 102 may be arranged into one or more groups, clusters, systems, or the like, e.g., at a site 111. Additionally, a plurality of sites 111 may be geographically dispersed from each other such as for providing data replication, disaster recovery protection, or the like. Further, in some cases, the service computing devices 102 at a plurality of different sites 111 may be configured for securely communicating with each other, such as for providing a federation of a plurality of sites 111. In other examples, one or more of the service computing devices 102 may be located separately from others of the service computing devices 102.

The one or more networks 106 may include any suitable network, including a wide area network, such as the Internet; a local area network (LAN), such as an intranet; a wireless network, such as a cellular network, a local wireless network, such as Wi-Fi, and/or short-range wireless communications, such as BLUETOOTH®; a wired network including Fibre Channel, fiber optics, Ethernet, or any other such network, a direct wired connection, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the service computing devices 102, the network storage system(s) 104, the user devices 108, and the administrator devices 110 are able to communicate over the one or more networks 106 using wired or wireless connections, and combinations thereof.

In addition, the service computing devices 102 may be able to communicate with each other over one or more networks 107. In some cases, the one or more networks 107 may be a LAN, private network, or the like, while in other cases, the one or more networks 107 may include any of the networks 106 discussed above.

The service computing devices 102 may be configured to provide storage and data management services to users 112 via the user devices 108, respectively. As several non-limiting examples, the users 112 may include users performing functions for businesses, enterprises, organizations, governmental entities, academic entities, or the like, and which may include storage of very large quantities of data in some examples. Nevertheless, implementations herein are not limited to any particular use or application for the system 100 and the other systems and arrangements described herein.

Each user device 108 may be any suitable type of computing device such as a desktop, laptop, tablet computing device, mobile device, smart phone, wearable device, terminal, and/or any other type of computing device able to send data over a network. Users 112 may be associated with user devices 108 such as through a respective user account, user login credentials, or the like. Furthermore, the user devices 108 may be able to communicate with the service computing device(s) 102 through the one or more networks 106, through separate networks, or through any other suitable type of communication connection. Numerous other variations will be apparent to those of skill in the art having the benefit of the disclosure herein.

Further, each user device 108 may include a respective instance of a user application 114 that may execute on the user device 108, such as for communicating with a user web application 116 executable on the service computing device(s) 102. For instance, the user application 114 may be configured for sending user data, e.g., data objects, for storage on one or more of the network storage systems 104 and/or for receiving stored data from the network storage system(s) 104 through a data instruction 118 or the like. In some cases, the application 114 may include a browser or may operate through a browser, while in other cases, the application 114 may include any other type of application having communication functionality enabling communication with the user web application 116 over the one or more networks 106.

In some examples, the users 112 may store data to, and receive data from, the service computing device(s) 102 that their respective user devices 108 are in communication with. Accordingly, the service computing devices 102 may provide storage for the users 112 and respective user devices 108. During steady state operation there may be users 108 periodically communicating with the service computing devices 102.

In some examples, herein data instructions 118 may be received by the service computing devices 102 from the user devices 108. For instance, each data instruction 118 may correspond to one or more “events”. In addition, event notifications about the events may be generated by the service computing devices 102 for at least some of the events consumed from the queues, and may be forwarded to one or more application computing devices (not shown in FIG. 1) that receive event notifications such as for logging, tracking, and/or managing certain activities performed with respect to the service computing devices 102 and/or with respect to the data stored by the service computing devices 102.

In addition, the administrator device 110 may be any suitable type of computing device such as a desktop, laptop, tablet computing device, mobile device, smart phone, wearable device, terminal, server, and/or any other type of computing device able to send data over a network. For instance, administrators 121 may be associated with respective administrator devices 110, such as through a respective administrator account, administrator login credentials, or the like. Furthermore, the administrator device 110 may be able to communicate with the service computing device(s) 102 through the one or more networks 106, 107, through separate networks, or through any other suitable type of communication connection.

Further, each administrator device 110 may include a respective instance of an administrator application 122 that may execute on the administrator device 110, such as for communicating with a management web application 124 executable on the service computing device(s) 102, such as for sending management instructions for managing the system 100 and/or for sending management data for storage on the network storage system(s) 104 and/or for receiving stored management data from the network storage system(s) 104, such as through a management instruction 126 or the like. In some cases, the administrator application 122 may include a browser or may operate through a browser, while in other cases, the administrator application 122 may include any other type of application having communication functionality enabling communication with the management web application 124 over the one or more networks 106.

In addition, the service computing devices 102 may execute a management program 127 that may perform certain management tasks. For example, the management program 127 may perform operations that include receiving and validating application programming interface (API) requests received via one or more API(s) 128, such as for queue counts (e.g., from the administrative device 110 in the case that the administrative user dictates the queue counts). Thus, in some examples, the management program 127 may service management API requests received via the API(s) 128, such as from the administrative device 110. Additionally, in some examples, the management program 127 may perform other management tasks, such as to create, delete or otherwise manage queues and/or policy engine worker instances in the case that the management program 127 automatically determines load balancing decisions for the system 100.

The management program 127 may also interact with a publication-subscription (pub/sub) program 129 that is able to inform all participating parties of changes to the queue count and/or worker count so that the policy engine worker instances are each able to determine for themselves whether they should reconfigure their respective queue mappings. One example of a suitable pub/sub program is APACHE ZOOKEEPER™, although any persistent, distributed pub/sub program may be used in the examples herein. For example, the pub/sub program 129 may provide read/write/update with listening semantics. In some cases, the management program 127 may update configuration information for the pub/sub program 129.

The service computing devices 102 may execute a storage program 130, which may provide a gateway to the network storage system(s) 104, such as for sending data to be stored to the network storage system(s) 104 and for retrieving requested data from the network storage system(s) 104 or from local storage 132. In addition, the storage program 130 may manage the data stored by the system 100, such as for managing data retention periods, data protection levels, data replication, and so forth.

The service computing devices 102 may further include a metadata data structure, such as a metadata database (DB) 134, which may be divided into a plurality of metadata DB portions, such as partitions, and which may be distributed across a plurality of the service computing devices 102. For example, the metadata DB 134 may be used for managing object data 136 stored at the network storage system(s) 104 and local object data 137 stored at the local storage 132. The metadata DB 134 may include numerous metadata about the object data 136, such as information about individual objects, how to access the individual objects, storage protection levels for the objects, storage retention periods, object owner information, object size, object type, and so forth. Further, a metadata gateway program 138 may manage and maintain the metadata DB 134 such as for updating the metadata DB 134 as new objects are stored, old objects are deleted, objects are migrated, and the like, as well as providing access to the metadata in the metadata DB 134, such as for responding to requests for accessing data.

In addition, the service computing device(s) 102 may include a policy engine program 140 that may be executed to perform data synchronization with the network storage system(s) 104. In some cases, the policy engine program 140 may be a module of the storage program 130 or the management program 127, while in other cases, the policy engine program 140 may be a separate program. The policy engine program 140 may include or may access a self-management algorithm 141 that worker instances of the policy engine program may execute for self-determining whether to consume from a queue and/or other functions.

In some cases, the policy engine program 140 may operate in cooperation with a message queueing program 142 for synchronizing the object data 136 with the network storage system(s) 104. As mentioned above, examples of message queuing programs 142 that may be used in some examples of the system 100 herein may include open source multi-protocol message brokers such as RABBITMQ® and ACTIVEMQ®. However, implementations are not limited to any particular message queuing program. The message queuing program 142 may support a queuing framework 144 for providing a plurality of queues 145 for sending data (events) to the network storage systems 104.

Worker instances (not shown in FIG. 1) of the policy engine program 140 may synchronize the object data 136 asynchronously with the network storage system(s) 104. For example, rather than having to perform certain storage operations to the network storage system(s) 104 and complete the operations before reporting back to a user, the storage program 130 may store the object data to the local storage 132 as local object data 137, may add metadata for the object to the local metadata database 134, such as via the metadata gateway program 138, and my reply to the requesting device with a completion message, or the like. The storage program 130 may subsequently send the data to a queue 145 to asynchronously synchronize the data with one or more of the network storage system(s) 104 via one or more data synchronization operations 146.

In some cases, the management program 127 may employ the API(s) 128 for automatically adjusting a queue count in the system 100. For example, the management program 127 may gather metrics regarding queue and worker performance. Based on analysis of the gathered metrics, the management program 127 may determine whether the worker instances are over-utilized, under-utilized, and further may determine whether the queues are experiencing under subscription or over subscription. Based on the analysis, the management program 127 may scale up or down the queue count using API calls of the API(s) 128 to the message queuing program 142, and/or may scale up or down the worker count using API calls of the API(s) 128 to the policy engine program 140. Alternatively, in other examples, the administrative user 121 may employ API calls of the API(s) 128 to manually change the queue count or the worker count by sending API calls to the message queuing program 142 or the policy engine program 140, respectively.

The mechanisms of the API(s) 128 when queue counts are updated may be essentially the same whether initiated by the management program 127 or by the administrative user 121. If the queue count is to be increased, the API(s) 128 (or the management program 127) may validate that the queue count for the type does not exceed the worker count for the type. If this condition is not true, the API(s) 128 may return an error to the caller rejecting the request. Additionally, the API(s) 128 (or the management program 127) may determine the next sequence of the queue to add for the type that has been determined to require an increased scale, and may create a queue for the type that is being increased in scale. The API(s) 128 may cause the message queuing program 142 to start the newly created queue so that the new queue can begin accepting events.

On the other hand, if the queue count is to be decreased for a type of queue, the API(s) 128 (or the management program 127) may determine a queue to remove (e.g., one of the queues having the highest index value to maintain naming expectations). Further, the API(s) 128 may cause the message queuing program 142 to stop the selected queue from accepting additional event entries, and redistribute existing queue events to one or more remaining queues of the same type. Finally, the API(s) 128 may delete the selected queue.

Additionally, when the management program 127 determines to decrease the worker count, the management program 127 may select a worker instance that has been determined, based on the analysis, to be underutilized, and may send an API call to the policy engine program 140 to terminate the selected worker instance. Similarly, when increasing the worker count, the management program 127 may send an API call to the policy engine program 140 to start up a new worker instance of a selected type determined based on the analysis discussed above. Similarly, the administrative user 121 may manually cause the policy engine program 140 to increase or decrease the worker count by sending an instruction to the policy engine program 140 such as via one or more API calls of the API(s) 128. In some cases, multiple worker instances may execute on the same physical devices such as through execution of different respective processing threads for different respective worker instances on the service computing devices 102. In other cases, different worker instances may execute on different respective virtual machines, different respective physical machines, or any of numerous other variations, as will be apparent to those of skill in the art having the benefit of the disclosure herein. Furthermore, in some examples, rather that sending the API calls to the policy engine program 140 to increase or decrease the worker count, the API calls may be sent to an orchestration framework for performing these operations. An example of a suitable orchestration framework according to some implementations herein may include KUBERNETES®; however, implementations herein are not limited to this.

In some examples, worker instances of the policy engine program 140 may receive the events asynchronously by consuming an event from one of the queues 145. Each event received by the system 100, or generated within the system 100, can be queued into the message queuing framework 144 for further processing. In addition, the policy engine program 140 may provide a scalable service for processing asynchronous and scheduled events. For example, events polled from the messaging queues 145 may be sent to respective queues 156 at one or more of the network storage systems 104. In some examples, each network storage system 104 may provide its own queuing service 160 to provide queues 156 for receiving and distributing events, event notifications, and so forth.

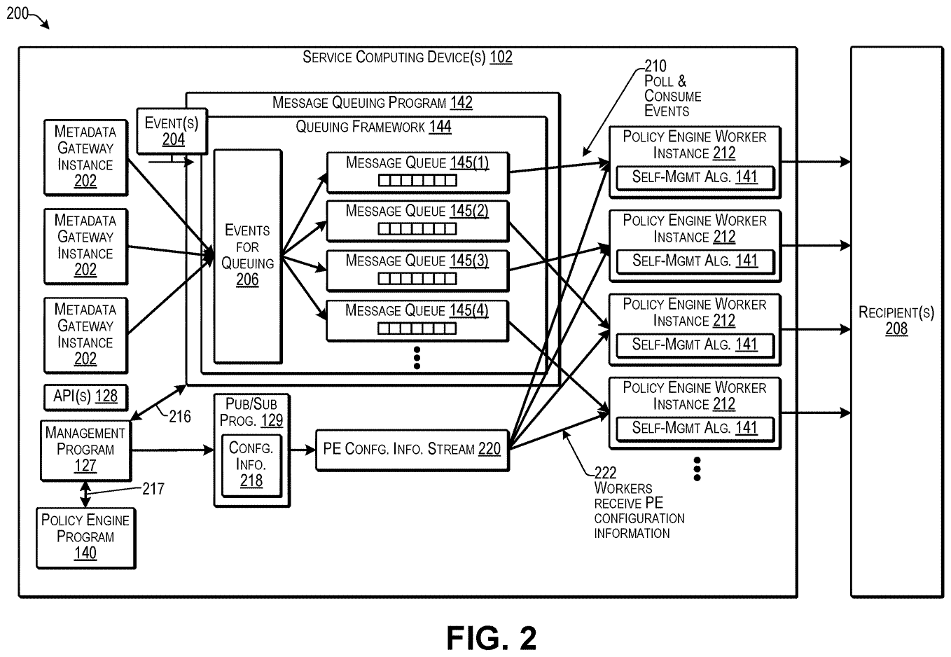

FIG. 2 is a block diagram illustrating an example logical configuration 200 of queuing and consumption operations according to some implementations. In some examples, the logical configuration 200 may correspond to the system 100 discussed above or any of various other possible computing system architectures, as will be apparent to those of skill in the art having the benefit of the disclosure herein. The logical configuration 200 may enable complex management and storage of data using resources distributed across local and cloud systems. In this example a plurality of metadata gateway instances 202 may provide events 204 to the message queuing program 142 for queuing in the message queuing framework 144. As mentioned above, examples of events 204 may include actions by users or the system 100 that affect stored data (e.g., the object data 136 in the example system 100 of FIG. 1), such as write requests, put requests, delete requests, move requests, and so forth. More generally, in some examples, the queues 145 may include three or more types, including (1) data exporter, which takes data internal to the system and exports the data out to some external target; (2) data importer, which takes data external to the system and imports the data into the system; and (3) notifier, which takes internal events and maps those to some external event sink.

In the illustrated example, the message queuing framework 144 may receive the events 204 for queuing as indicated at 206, and may distribute the events 204 to a plurality of message queues 145(1), 145(2), 145(3), 145(4), . . . . In some examples, at least some of the respective message queues 145 may be of a different type than others of the respective message queues 145, such as by being designated for sending events to different recipients 208, or for any of various other type designations. In some examples, the recipients 208 may be different storage systems 104, different queues at the same storage system 104, different computing devices, different applications, or any of numerous other recipient variations as will be apparent to those of skill in the art having the benefit of the disclosure herein.

The policy engine program 140 may be executed to provide a set of containerized services as a plurality of separate policy engine (PE) worker instances provided by the policy engine program 140 that, as indicated at 210, operate to poll and consume events from the queues 145, such as for respective recipients 208. For example, the PE worker instances 212 may pull synchronization events off the queue 145 asynchronously and may synchronize the events in the queue 145 to respective ones of the recipients 208. In some implementations, the queuing framework 216 may include a separate queue 145 for each separate recipient, such as a remote target domain. As one non-limiting example, the queuing framework 144 may include the first queue 145(1) for a first network storage system 104 (not shown in FIG. 2) managed by a first storage provider; a second queue 145(2) for a second network storage system 104 (not shown in FIG. 2) managed by a second storage provider, a third queue 145(3) and a fourth queue 145(4) for a third network storage system 104 (not shown in FIG. 2) managed by a third storage provider, and so forth.

As mentioned above, each instance of the policy engine program 140 may pull data for synchronization or other events 204 off one of the queues 145, and may send the data or other event to a specified recipient 208 (e.g., one of the network storage systems 104 discussed above, a respective queue on a respective network storage system 104, or the like). In the examples herein, the PE worker instances 212 determine to which queues they should bind. Jobs are not so much placed at a PE worker instance 212, as they are offered to a set of PE worker instances 212 via the queuing mechanism. A single queue is able to sustain performance across a set of the PE worker instances 212. If there are too few PE worker instances 212, the queue will be underserved and jobs will linger awaiting processing. If there are too many PE worker instances 212, the queue will not be able to offer enough work to keep them fed and PE worker instances 212 will be under-utilized.

In addition, each PE worker instance 212 may include, or may access the self-management algorithm 141 for self-determining the functions of that PE worker instance 212. For example, the management program 127 may collect or otherwise receive system configuration information indicating the current state of the queues 145. For instance, as indicated at 216 the management program 127 may communicate with the message queuing program 142 to receive current statuses of the message queues 145, such as how full the respective queues 145 are, how many of each queue 145 are allotted for each particular type designation, and so forth. Further, as indicated at 217. the management program 127 may also communicate with the policy engine program 140 to determine the state of the PE worker instances 212.

The management program 127 may continually provide this information to the pub/sub program 129 as policy engine configuration information 218, which the pub/sub program 129 makes available as a PE configuration stream 220. As indicated at 222, each of the PE worker instances 212 may the PE configuration information 218 through the policy engine configuration stream 220, and may execute the self-management algorithm 141 based on the received PE configuration information 218 for determining from which queue 145 to consume events.

In some examples, the pub/sub program maintains the global state of at least two pieces of information: (1) the number of PE worker instances 212 in the system and their identities, and (2) the desired queue counts (per-type). The PE worker instances 212 count may change based on scaling events (which may be instructed by the administrative use or may be instructed by the management program 127). Similarly, changes to queue counts may also be instructed by the administrative user or by the management program 127. The pub/sub program 129 may maintain this configuration information, and the PE worker instances 212 receive and use this to determine the a respective queue to which to assign themself. When a PE worker instance 212 determines to bind itself to a selected queue, the PE worker instance may send a binding request to the message queuing program 142, such as via an API call of the API(s) 128.

Accordingly, an individual PE worker instance 212 may execute its self-management algorithm 141 based on received configuration information and, based on the output of the algorithm 141, determines the queue 145 which it is to service. The PE worker instance 212 then binds itself to that selected queue 145, such as via an API call to the message queuing program to announce that it is a consumer that available to consume from the selected queue. Based on the PE worker instance 212 binding itself to a selected queue via the API call, the message queuing program 142 may begin to feed events from the selected queue 145 to the PE worker instance 212 for processing.

In the examples herein, the message queuing program 142 does not need to communicate with, and has no direct insight into the configuration information maintained by the pub/sub program 129. The message queuing program 142 becomes aware of consumers (PE worker instances 212) via their announcements using via the API(s) 128 (e.g., bind request or unbind request). Furthermore, the queues 145 may be created or removed as discussed above, such as based on an instruction from the administrative user or based on an instruction from the management program 127, which monitors the state of the configuration information 218 maintained by the pub/sub program 129, and which works toward driving the actual state of the system to that which is represented in the pub/sub program 129 as a desired state. As mentioned above, queue creation or deletion may be performed by the administrative user 121 or by the management program 127. The message queuing program 142 itself is not aware of the pub/sub program 129, or its intent.

In the examples herein, there does not need to be a one-to-one queue-to-worker relationship. For example, there may be a one-to-N queue-to-worker relationship for each queue 145, where N is an integer greater than zero. Accordingly, each message queue 145 may have at least one PE worker instance 212 for polling and consume events, but some of the message queues 145 may have multiple PE worker instances 212 for polling and consuming events.

In addition, each PE worker instance 212 may include, or may access the self-management algorithm 141 for self-determining the operation of that PE worker instance 212. For example, the management program 127 may collect or otherwise receive system configuration information indicating the current states of each of the queues 145. For instance, as indicated by arrow 216, the management program 127 may communicate with the message queuing program 142 to receive current statuses of each of the message queues 145, such as how full each of the respective queues 145 are, how many of each queue 145 are allotted to each particular type designation, and so forth, and may provide this information to the pub/sub program 129. Similarly, the management program 127 may receive information related to the PE worker instances 212 from the policy engine program 140.

The management program 127 may continually provide this system configuration information to the pub/sub program 129 as policy engine configuration information 218, which the message queueing program 142 may make available to the policy engine worker instances 212 as PE configuration stream 220. As discussed additionally below, the PE worker instances 212 may receive the PE configuration information 218 through the PE configuration stream 220 such as based on update notifications, and may execute the self-management algorithm 141 based on the received PE configuration information 218 for self-determining one of the queues 145 from which to consume events.

The PE configuration stream 220 provides a mechanism that enables the system 200 to distribute work across the set of queues 145 and allow for scaling of PE worker instances 212 to guarantee that each message queue 145 will be serviced and the PE worker instances 212 will distribute themselves fairly evenly across the set of queues 145. In the examples herein, the management program 127 and/or the administrative user can add/remove message queues 145 and/or PE worker instances 212, as discussed above, to achieve optimal system operation while ensuring that all message queues 145 remain serviced, even if the system topology changes.

In the examples herein, there is no “assignment” of the PE worker instances 212 to particular queues. Rather, in the examples herein, the queuing framework 144 holds submitted work and offers the work to the PE worker instances 212. The PE worker instances 212 pull and consume the work as they are available. As discussed above, the message queuing program 142 may be instructed, e.g., via one or more API calls, to add or remove queues 145 based on workload and availability. Further, as discussed above, the PE worker instances 212 can also be added or removed via one or more API calls based on load and availability. The self-management algorithm 141 may operate to cause the PE worker instances 212 to distribute themselves across the message queues in an optimal manner for balancing the respective loads of each of the PE worker instances 212 to be as equal as possible, while also ensuring that no message queue 145 is orphaned or otherwise abandoned. For instance, the PE worker instances 212 may each determine from which queue 145 to consume based on the self-management algorithm 141, which may take into consideration the current system topology, and without receiving assignments from a central authority.

Thus, in the examples herein, the message queues 145 and the PE worker instances 212 are decoupled. In particular, the PE worker instances 212 decide to which queues they should bind, such as based on the type of work which that PE worker instance 212 is able to perform. Further, clients may publish to the message queues 145 for the work they need to perform, but there is no affinity or tracking beyond this, and there is no need for a centralized component for selecting a particular worker for a particular queue. Rather, the system herein results in the queues and workers being self-managing.

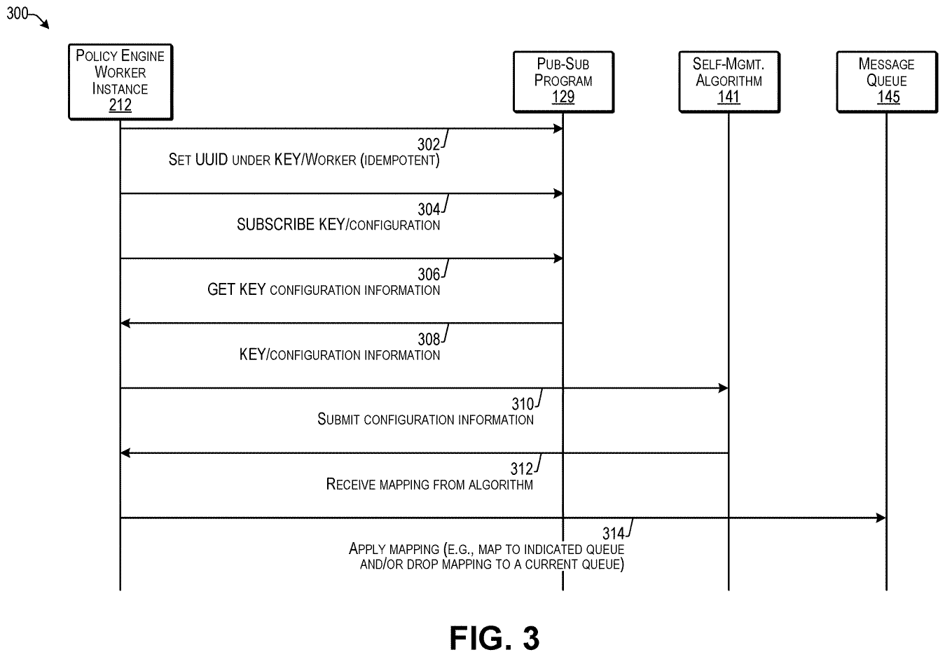

FIG. 3 is a sequence diagram illustrating an example process 300 by which, at start up, a PE worker instance maps itself to a queue or removes itself from a queue according to some implementations. In the examples herein, the pub/sub program 129 is able to inform all participating parties of changes to the queue count and/or worker count so that the PE worker instances 212 can each determine whether they should reconfigure their respective queue mappings.

Each PE worker instance 212 may maintain its own persistent identifier (ID) that is unique within the system, e.g., a “UUID” or any other individually distinguishable ID. Further, on startup, each PE worker instance 212 may perform initialization steps, which may include registering itself with the pub/sub program 129 to announce it is available and ready to perform work, subscribing for receiving change notifications from the pub/sub program 129, reading the current configuration, and determining its queue mapping.

At 302, upon each startup, the PE worker instance 212 may register its UUID idempotently to a common KEY/worker in the pub/sub program 129, thereby providing notification to other existing PE worker instances 212 of a configuration change.

At 304, the PE worker instance 212 may subscribe to the pub/sub program 129 for changes to a common KEY/configuration. For instance, in one aspect, the pub/sub program 129 may enable clients (e.g., PE worker instances 212) to set the value for a key and later retrieve that value back e.g., as a map type interface. Thus, a client can request notification to key “X” and if “X” is updated, the publication mechanism of the pub/sub program 129 may send an update to the listening client (the respective PE worker instance 212) indicating that the value under this key has changed and the client should execute its self-management algorithm to determine if a change is needed. Accordingly, by subscribing to the pub/sub program 129, the PE worker instances 212 are notified of scale events for other PE worker instances 212 (e.g., an increase or decrease in PE worker instance count) so that the individual PE worker instances can recompute their queue assignments.

At 306, the PE worker instance 212 may request (GET) the existing configuration information.

At 308, the PE worker instance 212 may receive the requested existing configuration from the pub/sub program 129, e.g., via the PE configuration information stream 220 discussed above with respect to FIG. 2.

At 310, the PE worker instance 212 may submit the configuration information to the self-management algorithm 141.

At 312, the PE worker instance 212 receives an indicated mapping to a queue from the self-management algorithm 141.

At 314, the PE worker instance 212 applies the received mapping, e.g., by mapping to the indicated message queue 145 and/or by dropping a mapping to a current message queue 145. As mentioned above, as one example, the PE worker instance 212 may send an API call to the message queuing program 142 to bind to a selected queue or to unbind from a previously bound queue.

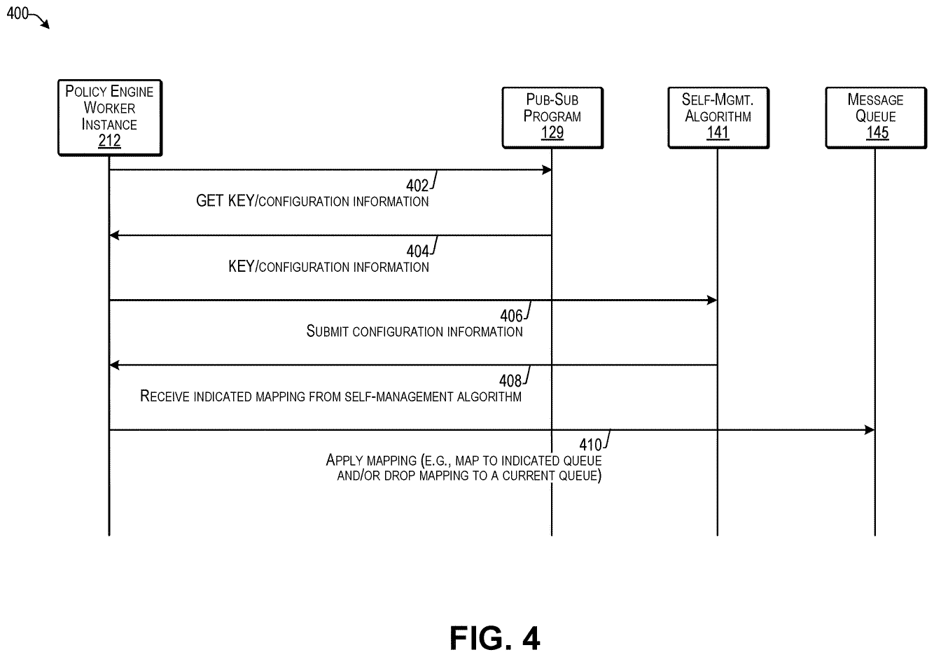

FIG. 4 is a sequence diagram illustrating an example process 400 by which a PE worker instance, during runtime, maps to a different queue and/or removes itself from a queue according to some implementations. For example, during runtime, the PE worker instance 212, as a subscriber of the pub/sub program 129 with which the PE worker instance 212 registered during initialization, invokes a handler that reads the current configuration of the system. The self-management algorithm 141 is used to recalculate an appropriate queue mapping for the PE worker instance 212 and adjust the queue consumption, if necessary.

As an example, suppose that a PE worker instance 212 that is currently assigned to queue X runs its self-management algorithm 141 based on the most recently received configuration information, and the self-management algorithm 141 determines that queue X should remain as the queue to which this PE worker instance 212 is mapped. In this situation, no further action is necessary. On the other hand, suppose that a PE worker instance 212 currently assigned to queue X runs its self-management algorithm 141 and the self-management algorithm 141 indicates that the PE worker instance 212 should be mapped to queue Y rather than queue X. Accordingly, the PE worker instance 212 may unbind itself from queue X, perform any necessary cleanup with respect to queue X, and then bind to queue Y and start consumption from queue Y.

At 402, the PE worker instance 212 may request (GET) the existing system configuration information.

At 404, the PE worker instance 212 may receive the requested existing system configuration information from the pub/sub program 129.

At 406, the PE worker instance 212 may submit the configuration information to the self-management algorithm 141.

At 408, the PE worker instance 212 receives an indicated mapping to a queue from the self-management algorithm 141.

At 410, the PE worker instance 212 applies the received mapping, e.g., by mapping to the indicated message queue 145 and/or by dropping a mapping to a current message queue 145.

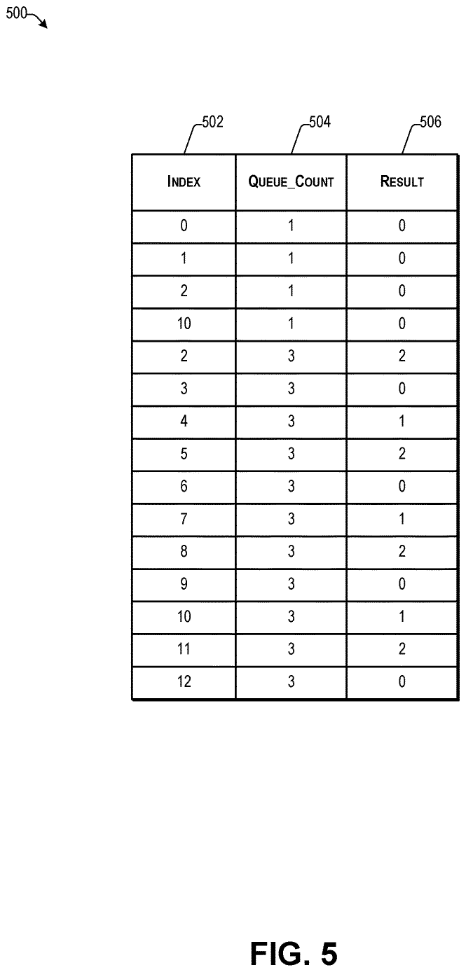

FIG. 5 illustrates an example data structure 500 used by the self-management algorithm 141 according to some implementations. In this example, the data structure 500 includes an index 502, a queue count 504, and result 506.

For example, the self-management algorithm 141 may receive: the UUID of the PE worker instance 212 making the mapping request; the type of queue targeted by the node; a consistently ordered list of PE worker instances 212 (e.g., ordered lexicographically by UUID) and according to type in the system; a current count of queues (per type) in the system; and a consistent well-defined naming pattern for the queues. In some examples, the PE worker instances 212 may have a fixed type similar to the respective queue types. In other examples, PE worker instances 212 may have multiple types and/or may perform multiple different types of work and/or may draw work from different types of queues.

As one example, the queue naming pattern may be of “type. count”. As one example, suppose that there are currently six queues in the system, two of a first type “processing-A”, three of a second type “processing-B”, and one of a third type “processing-C”. Based on the queue naming pattern of type. count, these six queues may be named as follows: processing-A.1, processing-A.2, processing-B.1, processing-B.2, processing-B.3, and processing-C.1.

In some examples, the management program 127 may be responsible for maintaining a contiguous one-to-N naming pattern for queues of a particular type with no holes. The self-management algorithm 141 may receive the UUID of the requesting PE worker instance 212 and the list of all PE worker instances 212. If the self-management algorithm 141 finds the requesting PE worker instance's UUID in the list, the algorithm may use the index 502 to determine a queue mapping using modulo division of index % queue_count to determine the result 506. For example, the algorithm performing the calculation has a list of PE worker instances 212 currently in the system and a list of queues (per type). Within the list of PE worker instances 212 is the “self” of the PE worker instance 212 executing the self-management algorithm 141. The algorithm orders the list to find the offset at which it is located within the list. So suppose in this example that there are currently three PE worker instances 212 in the system, i.e., instance A, instance B, and instance C. In this case, instance “B” would correspond to index “1” here. Based on applying this index value to the data structure 500, the at the index (502) column, the second row corresponds to the index value of “1”. The queue count is provided by the second area of configuration state maintained in the pub/sub program. Accordingly, based on desired type, the algorithm may determines the queue count and plugs that value in as the value for the queue_count 504. Index value modulo queue_count value results in the queue assignment value 506. The algorithm may then use the queue naming pattern described to identify the queue binding target based on type and result 506. Using the result 506 and the targeted type, the mapping algorithm builds the expected queue name to return the queue for the particular PE worker instance 212 to consume from, e.g., “processing-B.3” in this example.

Note that this algorithm may depend on the system (e.g., the management program 127) ensuring that the queue count for any particular queue type never exceeds the worker count, otherwise queues might be orphaned. Thus, a PE worker instance 212 may be solely responsible for listening to a single queue per type. Otherwise a more complicated mapping algorithm may be employed to ensure all queues have assigned workers, and with workers potentially being responsible for more than a single queue per type. This design requires that configuration management ensures there is a one-to-one or one-to-many relationship for queue-to-worker and also that a particular PE worker instance 212 is responsible for servicing a single queue type.

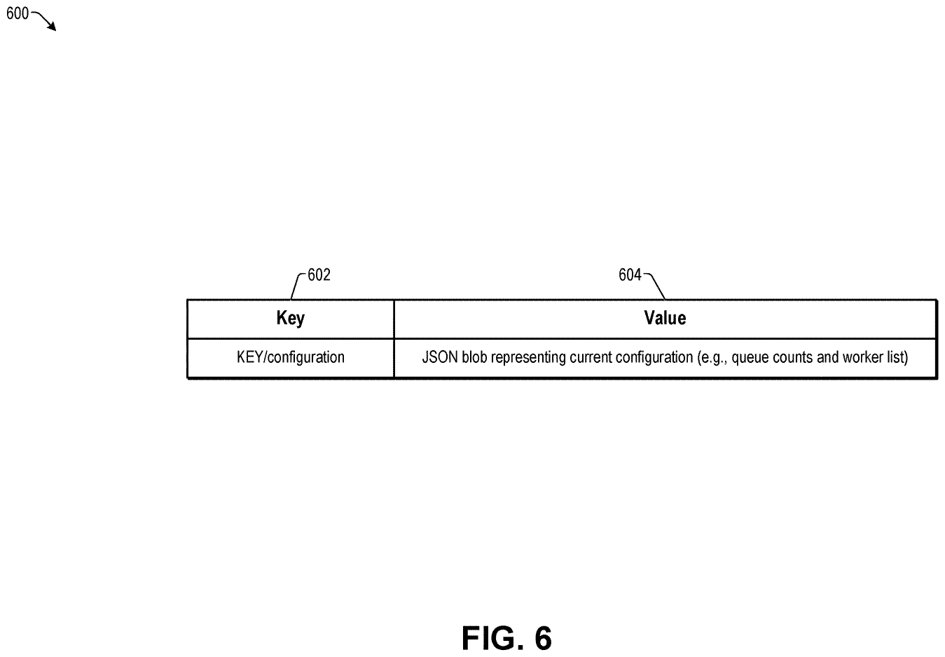

FIG. 6 illustrates an example of a data structure 600 for state tracking according to some implementations. In this example, the data structure 600 includes a key 602 and a value 604. For example, the key 602 is the KEY/configuration and the value 604 may be a JSON blob or any other data format that represents the current system configuration, and which may include information such as the current queue count and a list of the PE worker instances 212 that currently exist in the system. In some examples, the pub/sub program 129 may be configured to track the state of the queues and the PE worker instances 212, as the pub/sub program 129 may provide persistence, redundancy, and notifications.

The key 602 should be readable by all PE worker instances 212, and only the management program 127 should write the value 604. All PE worker instances 212 register a watcher/listener with the pub/sub program 129. When the value 604 changes, the PE worker instances 212 may each recalculate their mappings based on the latest configuration represented by the value 604. This simplifies the worker logic by only subscribing to a single source for receiving the current system state information, which can be read from a single location, and which can also simplify debugging.

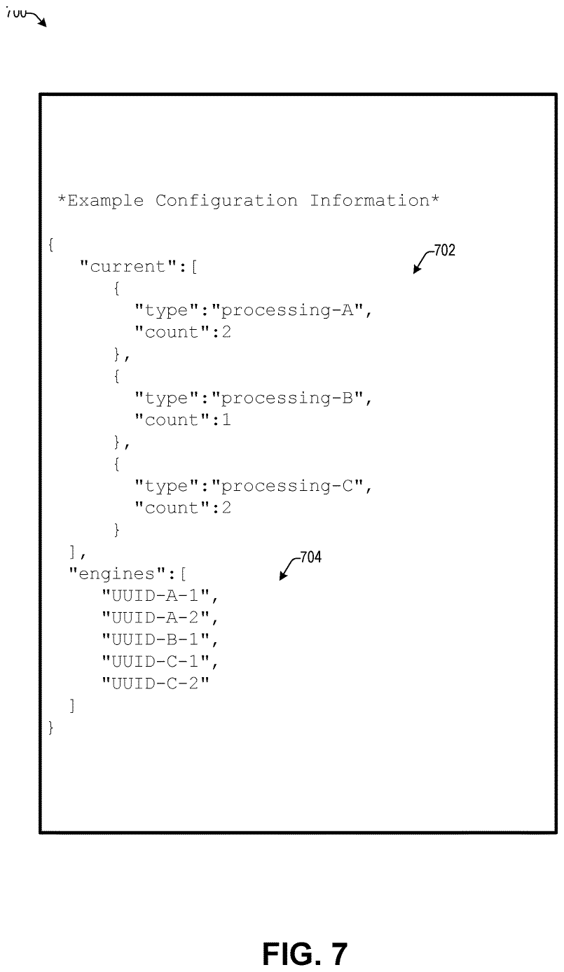

FIG. 7 illustrates example pseudocode 700 showing an example of a current system state according to some implementations. For example, in FIG. 7, there are three types of queues, namely, “processing-A”, “processing-B”, and “processing-C”, with the current count of each type being shown, following the type, as indicated at 702. In addition the “engines” indicates the UUIDs of the PE worker instances 212 that are currently associated with each of the queues, respectively, as indicated at 704.

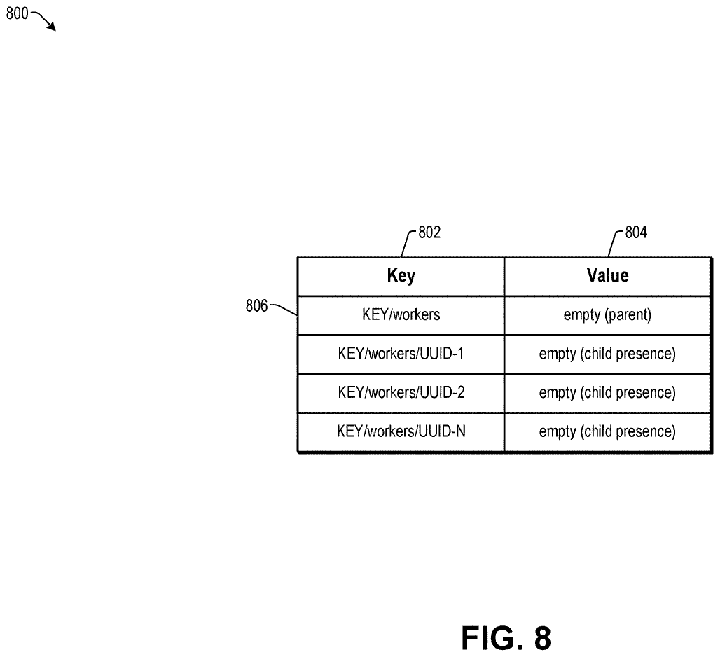

FIG. 8 illustrates an example data structure 800 that the pub/sub program 129 may use to track the PE worker instances according to some implementations. In this example, the data structure 800 includes a key 802 and a value 804. The key 802 may be readable by all PE worker instances 212. Further, only PE worker instances 212 should write under the parent key 806 to announce their addition or removal from the system. As mentioned above, e.g., with respect to FIG. 3, when a PE worker instance 212 initializes, that PE worker instance 212 will add itself to the data structure 800 as a child node if it does not already have an entry present in the data structure 800. When a PE worker instance 212 is decommissioned permanently, that PE worker instance 212 may remove its associated child node entry from the data structure 800.

As one example, the management program 127 may register a recursive, persistent listener with the pub/sub program 129. For example, the listener (the management program 127) registers a subscription with the pub/sub program 129 to be notified of events published by the pub/sub program 129 to subscribers. The management program 127 may react to any additions or deletions of PE worker instances 212 by regenerating the current configuration JSON and updating the configuration node value if it has changed, which signals to the PE worker instances 212 that they should recalculate their mappings. This operation should output the worker list with a consistent ordering so that each worker can index itself into the list in a consistent manner without re-ordering. If a PE worker instance 212 does not find itself in the list under column 802, it must wait and/or retry on the assumption that the management task is still calculating the state or the updated state has not refreshed cached values.

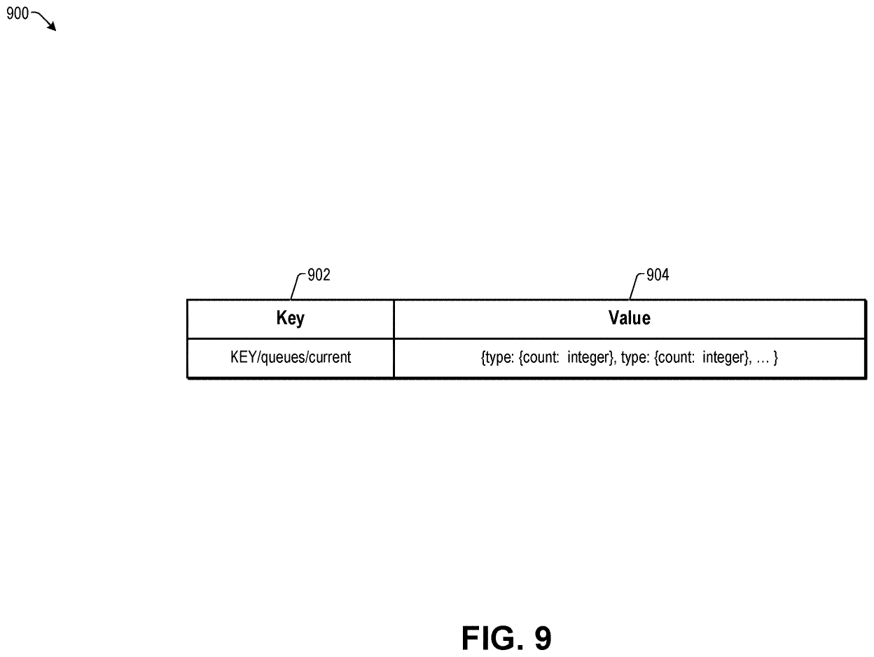

FIG. 9 illustrates an example data structure 900 indicating current queue type counts according to some implementations. In this example, the data structure 900 includes a key 902 and a value 904. In the data structure 900, “current” represents the active configuration which may be feeding the queue portion of the configuration node, and which may always be present. Accordingly, the data structure 900 provides the queue allocation for the system. As previously discussed this may be determined by the administrative user and/or set via management program 127. In some examples, the management program 127 may include an automated process that monitors and decides to scale queues up/down. Thus, the data structure 900 may be updated in response to a change in the queue count.

FIG. 10 illustrates select example components of the service computing device(s) 102 that may be used to implement at least some of the functionality of the systems described herein. The service computing device(s) 102 may include one or more servers or other types of computing devices that may be embodied in any number of ways. For instance, in the case of a server, the programs, other functional components, and data may be implemented on a single server, a cluster of servers, a server farm or data center, a cloud-hosted computing service, and so forth, although other computer architectures may additionally or alternatively be used. Multiple service computing device(s) 102 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, the service computing device(s) 102 includes, or may have associated therewith, one or more processors 1002, one or more computer-readable media 1004, and one or more communication interfaces 1006. Each processor 1002 may be a single processing unit or a number of processing units, and may include single or multiple computing units, or multiple processing cores. The processor(s) 1002 can be implemented as one or more central processing units, microprocessors, microcomputers, microcontrollers, digital signal processors, state machines, logic circuitries, and/or any devices that manipulate signals based on operational instructions. As one example, the processor(s) 1002 may include one or more hardware processors and/or logic circuits of any suitable type specifically programmed or configured to execute the algorithms and processes described herein. The processor(s) 1002 may be configured to fetch and execute computer-readable instructions stored in the computer-readable media 1004, which may program the processor(s) 1002 to perform the functions described herein.

The computer-readable media 1004 may include volatile and nonvolatile memory and/or removable and non-removable media implemented in any type of technology for storage of information, such as computer-readable instructions, data structures, program modules, or other data. For example, the computer-readable media 1004 may include, but is not limited to, RAM, ROM, EEPROM, flash memory or other memory technology, optical storage, solid state storage, magnetic tape, magnetic disk storage, storage arrays, network attached storage, storage area networks, cloud storage, or any other medium that can be used to store the desired information and that can be accessed by a computing device. Depending on the configuration of the service computing device(s) 102, the computer-readable media 1004 may be a tangible non-transitory medium to the extent that, when mentioned, non-transitory computer-readable media exclude media such as energy, carrier signals, electromagnetic waves, and/or signals per se. In some cases, the computer-readable media 1004 may be at the same location as the service computing device 102, while in other examples, the computer-readable media 1004 may be partially remote from the service computing device 102.

The computer-readable media 1004 may be used to store any number of functional components that are executable by the processor(s) 1002. In many implementations, these functional components comprise instructions or programs that are executable by the processor(s) 1002 and that, when executed, specifically program the processor(s) 1002 to perform the actions attributed herein to the service computing device 102. Functional components stored in the computer-readable media 1004 may include the user web application 116, the management web application 124, the management program 127, the API(s) 128, the pub/sub program 129, the storage program 130, the metadata gateway program 138, the policy engine program 140, including the self-management algorithm 141, and the message queuing program 142, each of which may include one or more computer programs, applications, executable code, or portions thereof. Further, while these programs are illustrated together in this example, during use, some or all of these programs may be executed on separate service computing devices 102.

In addition, the computer-readable media 1004 may store data, data structures, and other information used for performing the functions and services described herein. For example, the computer-readable media 1004 may store the metadata database 134 and the local object data 137. Further, while these data structures are illustrated together in this example, during use, some or all of these data structures may be stored on separate service computing devices 102. The service computing device 102 may also include or maintain other functional components and data, which may include programs, drivers, etc., and the data used or generated by the functional components. Further, the service computing device 102 may include many other logical, programmatic, and physical components, of which those described above are merely examples that are related to the discussion herein.

The one or more communication interfaces 1006 may include one or more software and hardware components for enabling communication with various other devices, such as over the one or more network(s) 106 and 107. For example, the communication interface(s) 1006 may enable communication through one or more of a LAN, the Internet, cable networks, cellular networks, wireless networks (e.g., Wi-Fi) and wired networks (e.g., Fibre Channel, fiber optic, Ethernet), direct connections, as well as close-range communications such as BLUETOOTH®, and the like, as additionally enumerated elsewhere herein.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, the implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

Various instructions, methods, and techniques described herein may be considered in the general context of computer-executable instructions, such as computer programs and applications stored on computer-readable media, and executed by the processor(s) herein. Generally, the terms program and application may be used interchangeably, and may include instructions, routines, modules, objects, components, data structures, executable code, etc., for performing particular tasks or implementing particular data types. These programs, applications, and the like, may be executed as native code or may be downloaded and executed, such as in a virtual machine or other just-in-time compilation execution environment. Typically, the functionality of the programs and applications may be combined or distributed as desired in various implementations. An implementation of these programs, applications, and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more processors configured by executable instructions to perform operations comprising:
generating a plurality of queues configured to receive data; and
generating a plurality of worker instances, each worker instance configured to be associated with a respective queue of the plurality of queues for consuming data from the respective queue, wherein individual worker instances of the plurality of worker instances are configured to perform actions including:
receiving system configuration information indicating a state of the respective queues of the plurality of queues and a state of respective worker instances of the plurality of worker instances; and
determining, by each of the individual worker instances, based at least in part on the received system configuration information, whether to change an association of the individual worker instance from the respective queue with which the individual worker instance is currently associated to a different queue of the plurality of queues,
wherein, based at least on the received system configuration information, at least one of the individual worker instances determines to change association from consuming data from a first one of the queues, to consuming data from a second one of the queues.

2. The system as recited in claim 1, wherein the system configuration information further includes an indication of a type of each respective queue and a count of a number of the queues of each type in the system.

3. The system as recited in claim 2, wherein the type of each respective queue is based at least in part on a characteristic of the data received by the respective queue.

4. The system as recited in claim 2, wherein the system configuration information further includes an indication of which worker instances are associated with which respective queues.

5. The system as recited in claim 1, wherein, following generation of a respective worker, the respective worker registers to receive the system configuration information at least in response to a change in the system configuration.

6. The system as recited in claim 1, wherein the data received by the queues and consumed by the worker instances corresponds to a plurality of respective events, wherein at least some of the respective events correspond to data operations comprising at least one of: a write request, a put request, a delete request, or a move request.

7. The system as recited in claim 1, the operations further comprising:
receiving metrics regarding queue and worker performance;
based at least on the received metrics, determining to add a queue to the plurality of queues; and
sending an application programming interface (API) call to a message queuing program executing on the one or more processors to cause the message queuing program to generate a new queue.

8. The system as recited in claim 1, wherein the plurality of worker instances are configured to receive the system configuration information from a publication/subscription program that maintains the system configuration information.

9. The system as recited in claim 1, wherein the worker instances are configured to ensure that each queue is associated with at least one worker instance.

10. The system as recited in claim 1, the operations further comprising, sending, by the individual worker instances, the data consumed from the respective queues to respective target recipients.

11. The system as recited in claim 1, wherein the at least one of the individual worker instances that determined to change association from consuming data from the first one of the queues, to consuming data from the second one of the queues sends a first application programming interface (API) call to unbind from the first queue, and sends a second API call to bind to the second queue.

12. A method comprising:
generating, by one or more processors, a plurality of queues configured to receive data; and
generating, by the one or more processors, a plurality of worker instances, each worker instance configured to be associated with a respective queue of the plurality of queues for consuming data from the respective queue, wherein individual worker instances of the plurality of worker instances are configured to perform actions including:
receiving system configuration information indicating a state of the respective queues of the plurality of queues and a state of respective worker instances of the plurality of worker instances; and
determining, by each of the individual worker instances, based at least in part on the received system configuration information, whether to change an association of the individual worker instance from the respective queue with which the individual worker instance is currently associated to a different queue of the plurality of queues,
wherein, based at least on the received system configuration information, at least one of the individual worker instances determines to change association from consuming data from a first one of the queues, to consuming data from a second one of the queues.

13. The method as recited in claim 13, wherein the system configuration information further includes an indication of a type of each respective queue and a count of a number of the queues of each type in the system.

14. A non-transitory computer-readable medium storing instructions that, when executed by one or more processors, configure the one or more processors to perform operations comprising:
generating a plurality of queues configured to receive data; and
generating a plurality of worker instances, each worker instance configured to be associated with a respective queue of the plurality of queues for consuming data from the respective queue, wherein individual worker instances of the plurality of worker instances are configured to perform actions including:
receiving system configuration information indicating a state of the respective queues of the plurality of queues and a state of respective worker instances of the plurality of worker instances; and
determining, by each of the individual worker instances, based at least in part on the received system configuration information, whether to change an association of the individual worker instance from the respective queue with which the individual worker instance is currently associated to a different queue of the plurality of queues,
wherein, based at least on the received system configuration information, at least one of the individual worker instances determines to change association from consuming data from a first one of the queues, to consuming data from a second one of the queues.

15. The non-transitory computer-readable medium as recited in claim 14, wherein the system configuration information further includes an indication of a type of each respective queue and a count of a number of the queues of each type in the system.
